(19) United States
(12) Patent Application Publication
(10) Pub. No.: US 2015/0049196 A1
(43) Pub. Date: Feb. 19, 2015

(54) APPARATUS AND METHOD FOR COMPOSITION IMAGE FOR AVM SYSTEM

(71) Applicant: HYUNDAI MOBIS CO., LTD., Seoul (KR)

(72) Inventor: Seok Tae KANG, Yongin-si (KR)

(73) Assignee: HYUNDAI MOBIS CO., LTD., Seoul (KR)

(21) Appl. No.: 14/457,532

(22) Filed: Aug. 12, 2014

(30) Foreign Application Priority Data
Aug. 13, 2013 (KR) 10-2013-0095714

(51) Int. Cl. G06T 3/40; G09G 5/14; H04N 7/18

(52) U.S. Cl. CPC G06T 3/4038; H04N 7/181; G09G 5/14
USPC 348/148

(57) ABSTRACT

An image composing apparatus includes an image input unit which captures original images using front, rear, left, and right cameras of a vehicle; an external memory which stores the original images, a look up table, and a composite image; an original image window generating unit which sets an M×N basic pixel group to analyze a coordinate value based on the look up table and calculates a starting coordinate and a window size of the window in accordance with the coordinate value; an internal memory control unit which reads the original images in accordance with the starting coordinate and the window size to store the original image; an image composing unit which composes the original images read out based on the coordinate value to generate the composite image; and an image output unit which reads the composite image to output the composite image to a display device.

### CROSS-REFERENCE TO RELATED APPLICATION

This application claims the benefit under 35 U.S.C. 119(a) of Korean Patent Application No. 10-2013-0095714 filed in the Korean Intellectual Property Office on Aug. 13, 2013, the entire disclosure of which is incorporated herein by reference for all purposes.

### BACKGROUND

1. Field

The present invention relates to an AVM system and more particularly, to an image composing apparatus and method which compose four images from front, rear, left, and right sides of a vehicle into one image.

2. Description of Related Art

An around view monitoring (AVM) system receives original images from four cameras at front, rear, left, and right sides of a vehicle to compose the original images into one image and output the composed image to a display device.

The AVM system stores the original images input from the camera into an external memory and reads a look up table which is generated from an image pre-processing process to be stored in the external memory to extract an original image coordinate value for composing the images. The AVM system performs bi-linear interpolation on the original image data which is read from the external memory based on the coordinate value and stores the original image data in the external memory as an output coordinate again. The AVM system performs the above process on each of the front, rear, left, and right images and then outputs the image composite result data in accordance with the output coordinate.

In this case, a camera of the AVM system is a wide angle camera and a distortion which is similar to a sphere shape. The AVM system corrects the distorted image using a backward mapping method at the time of composing the image to flatten the distorted image in the unit of pixel in the order of the left, right, upper, and lower sides. Original image data which is required in a distortion correcting process and an image composing process is read from the external memory and a single read method is used in this case.

However, according to the single read method, an access frequency to the external memory is high and a high memory frequency is required to satisfy a processing speed required for the system, and a delay time is increased due to an additional time for executing a command.

### SUMMARY

The present invention provides an image composing apparatus and method for an AVM system in which an external memory access efficiency is improved by changing a method of reading an external memory which is generated during a distortion correcting and composing process at the time of composing images.

The present invention has been made in an effort to provide an image composing apparatus, including: an image input unit which captures original images which are captured by front, rear, left, and right cameras of a vehicle; an external memory which stores the captured original images, a look up table, and a composite image; an original image window generating unit which sets an M×N basic pixel group to analyze a coordinate value based on the look up table and calculates a starting coordinate and a window size of the window in accordance with the coordinate value; an internal memory control unit which reads the original images from the external memory in accordance with the starting coordinate and the window size to store the original image in an internal memory; an image composing unit which composes the original images read out from the internal memory based on the coordinate value to generate the composite image; and an image output unit which reads the composite image from the external memory to output the composite image to a display device.

The original image window generating unit may perform pixel processing by grouping the M×N basic pixels.

The original image window generating unit may calculate the window size based on the basic pixel group.

The internal memory control unit may transmit the coordinate values as many as the number of M×N basic pixels to the image composing unit.

The present invention has been made in an effort to further provide an image composing method, including: initializing an around view monitoring (AVM) system; capturing images at front, rear, left, and right sides of a vehicle to store the images in an external memory as four original images; calculating a starting coordinate and a window size of a window based on an M×N basic pixel group and a look up table which are read out from the external memory; storing the original images corresponding to the starting coordinate and the window size in an internal memory; composing the original images which are read out from the internal memory to store the original images in the external memory as a composite image; and outputting the composite image to a display device.

The calculating may analyze the coordinate value based on the look up table which is read out from the external memory as a window having the basic pixel group unit and calculate the starting coordinate and the window size in accordance with the coordinate value.

The storing as a composite image may store the coordinate values as many as the number of M×N basic pixels as a coordinate value of the composite image.

According to the image composing apparatus and method according to the exemplary embodiments of the present invention, an external memory access frequency is lowered and an image processing delay time is minimized by accessing the external memory by a burst read mode, thereby improving a performance.

### BRIEF DESCRIPTION OF THE DRAWINGS

FIG. 1 is a block diagram illustrating an image composing apparatus according to an exemplary embodiment of the present invention.

FIG. 2 is a flowchart illustrating an image composing method according to an exemplary embodiment of the present invention.

FIG. 3 is a conceptual diagram illustrating a basic pixel group unit according to an exemplary embodiment of the present invention.

FIG. 4 is a conceptual diagram illustrating backward mapping using a window according to an exemplary embodiment of the present invention.

FIG. 5 is a timing chart illustrating an external memory accessing method according to an exemplary embodiment of the present invention.

### DETAILED DESCRIPTION

Specific structural or functional descriptions of exemplary embodiments in accordance with a concept of the present invention which are disclosed in this specification are illustrated only to describe the exemplary embodiments in accordance with the concept of the present invention and the exemplary embodiments in accordance with the concept of the present invention may be carried out by various forms but the present invention is not limited to the exemplary embodiments described in this specification.

Various modifications and changes may be applied to the exemplary embodiments in accordance with the concept of the present invention so that the exemplary embodiments will be illustrated in the drawings and described in detail in the specification. However, the exemplary embodiments according to the concept of the present invention is not limited to the specific embodiments, but includes all changes, equivalents, or alternatives which are included in the spirit and technical scope of the present invention.

Terminologies such as first or second may be used to describe various components but the components are not limited by the above terminologies. The above terminologies are used to distinguish one component from the other component, for example, a first component may be referred to as a second component without departing from a scope in accordance with the concept of the present invention and similarly, a second component may be referred to as a first component.

It should be understood that, when it is described that an element is “coupled” or “connected” to another element, the element may be directly coupled or directly connected to the other element or coupled or connected to the other element through a third element. On the contrary, it should be understood that when an element is referred to as being “directly connected to” or “directly coupled to” another element, another element does not intervene therebetween. Other expressions which describe the relationship between components, that is, “between” and “directly between”, or “adjacent to” and “directly adjacent to” need to be interpreted by the same manner.

Terminologies used in the present specification are used only to describe specific exemplary embodiments, and are not intended to limit the present invention. A singular form may include a plural form if there is no clearly opposite meaning in the context. In the present specification, it should be understood that terms “include” or “have” indicate that a feature, a number, a step, an operation, a component, a part or the combination thoseof described in the specification is present, but do not exclude a possibility of presence or addition of one or more other features, numbers, steps, operations, components, parts or combinations thereof, in advance.

If it is not contrarily defined, all terms used herein including technological or scientific terms have the same meaning as those generally understood by a person with ordinary skill in the art. Terminologies which are defined in a generally used dictionary should be interpreted to have the same meaning as the meaning in the context of the related art but are not interpreted as an ideally or excessively formal meaning if they are not clearly defined in this specification.

Hereinafter, the present invention will be described in detail by explaining exemplary embodiments of the present invention with reference to the accompanying drawings.

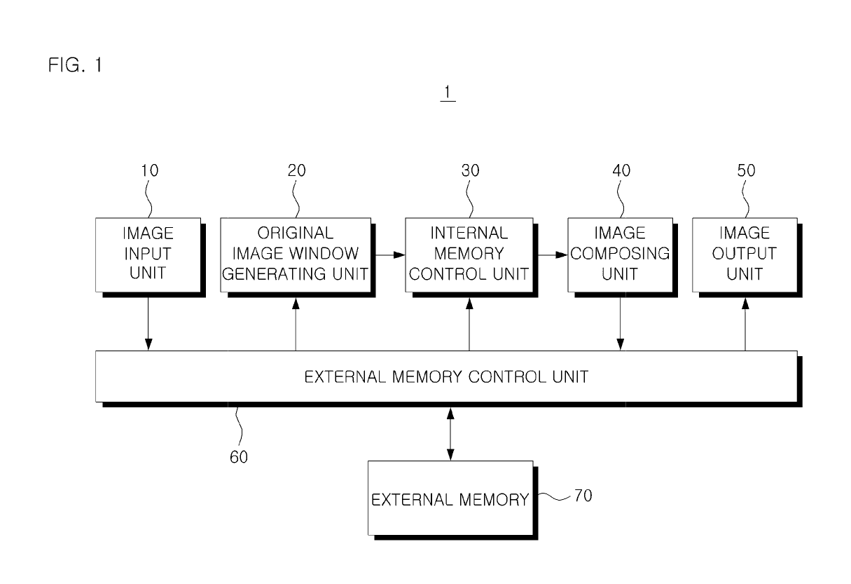

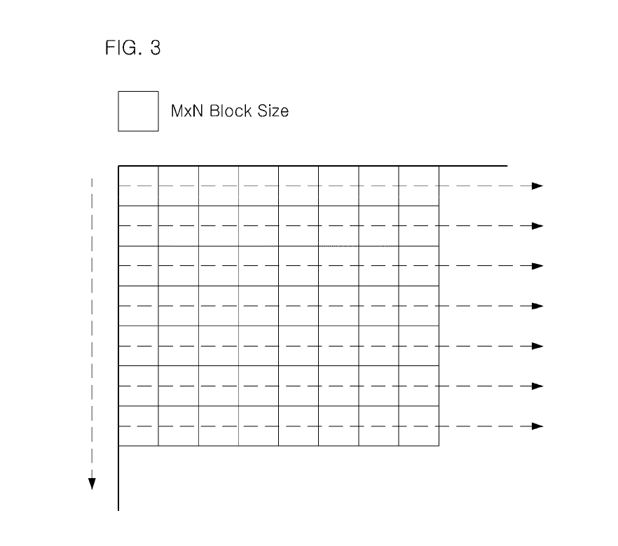

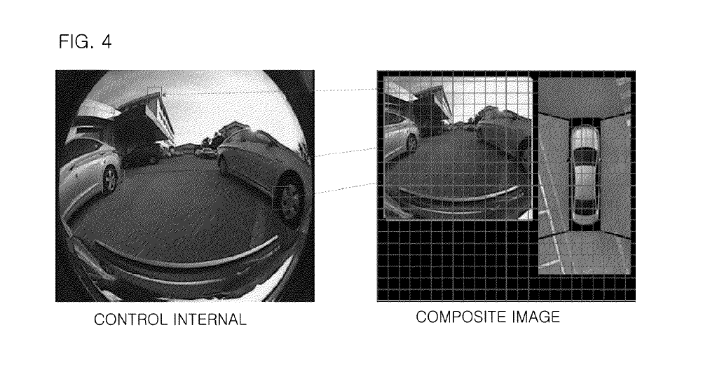

FIG. 1 is a block diagram illustrating an image composing apparatus according to an exemplary embodiment of the present invention, FIG. 3 is a conceptual diagram illustrating a basic pixel group unit according to an exemplary embodiment of the present invention, and FIG. 4 is a conceptual diagram illustrating backward mapping using a window according to an exemplary embodiment of the present invention.

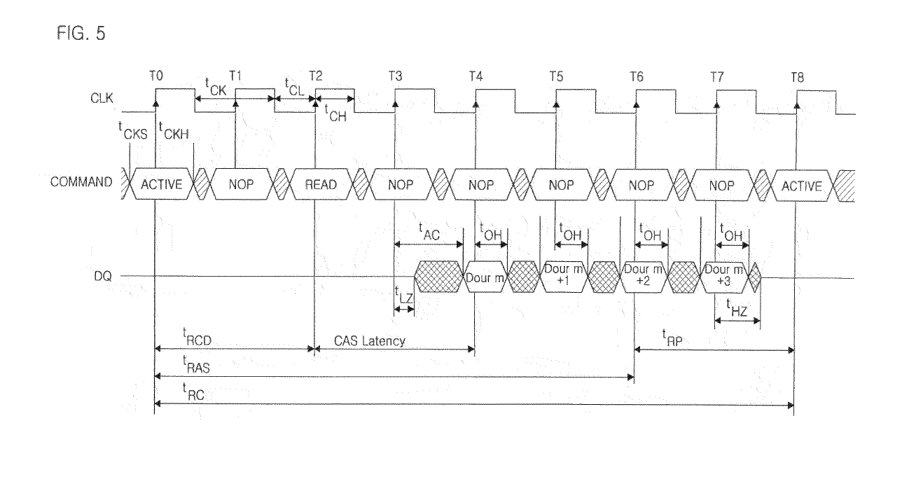

Referring to FIG. 1, an image composing apparatus 1 includes an image input unit 10, an original image window generating unit 20, an internal memory control unit 30, an internal memory 35, an image composing unit 40, an image output unit 50, an external memory control unit 60, and an external memory 70. FIG. 5 is a timing chart illustrating an external memory accessing method according to an exemplary embodiment of the present invention.

The image input unit 10 captures original images which are captured by front, rear, left, and right cameras of the camera.

The original image window generating unit 20 sets an M×N basic pixel group to analyze a coordinate value based on the look up table and calculates a starting coordinate and a window size of the window in accordance with the coordinate value.

More specifically, the original image window generating unit 20 sets an M×N basic pixel group for an image composition processing. In the related art, the pixel processing order is a left side to a right side and an upper side to a lower side of the entire pixel array of the image but in the exemplary embodiment of the present invention, as illustrated in FIG. 3, the pixel processing order is a left side to a right side and an upper side to a lower side of the M×N basic pixel group. As a result, a computational complexity is reduced so that the processing speed of the image composition is improved. In this case, M and N are natural numbers of 1 or larger.

The original image window generating unit 20 reads a look up table (LUT) from the external memory 70 to extract an X-Y coordinate value which is used for backward mapping. The original image window generating unit 20 analyzes the extracted X-Y coordinate to calculate a starting coordinate and a window size of a window which is stored in the external memory 70. In this case, the window size is not uniform and may be various in accordance with the exemplary embodiment. In the related art, when a distortion is corrected, the backward mapping is performed by pixel by pixel so that the computational complexity is high. In contrast, according to the exemplary embodiment of the present invention, the backward mapping is performed in the unit of window, as illustrated in FIG. 4, to correct the distortion, thereby reducing the computational complexity.

The original image window generating unit 20 notifies the internal memory control unit of the calculated starting coordinate and window size of the window.

The internal memory control unit 30 controls access to the internal memory 35. For example, the internal memory control unit 30 reads out the original image from the external memory 70 and stores the original image in the internal memory in accordance with the starting coordinate and the window size of the window. Further, the internal memory control unit 30 transmits look up table data (that is, X-Y coordinate values) as many as the number of M×N basic pixels to the image composing unit 40.

The internal memory 35 stores the original image corresponding to the starting coordinate and the window size of the window in order to compose the images. The internal memory may be a volatile memory, for example, a static random access memory (SRAM).

The image composing unit 40 performs image composition on the original images which are read out from the internal memory 35 and generates a composite image using the look up table data as many as the number of M×N basic pixels. The image composing unit 40 transmits the composite image to the external memory 70.

The image output unit 50 reads the composite image from the external memory 70 to output the composite image to a display device (not illustrated).

The external memory control unit 60 controls access to the external memory 70. The external memory control unit 60 may access the external memory 70 by a burst read mode illustrated in FIG. 5. Referring to FIG. 5, when a read command is received at T2, the external memory control unit 60 receives a plurality of effective data during T3 to T8 by one read command through a data line. As a result, a processing delay time for the read command is reduced as compared with the single read mode of the related art and a memory access operation for temporally storing an image required for the image composition is shared with the internal memory so that an access frequency to the external memory is reduced.

The external memory 70 stores the captured original image, the look up table, and the composite image. The external memory 70 may be a nonvolatile memory or a volatile memory, for example, a dynamic random access memory (DRAM).

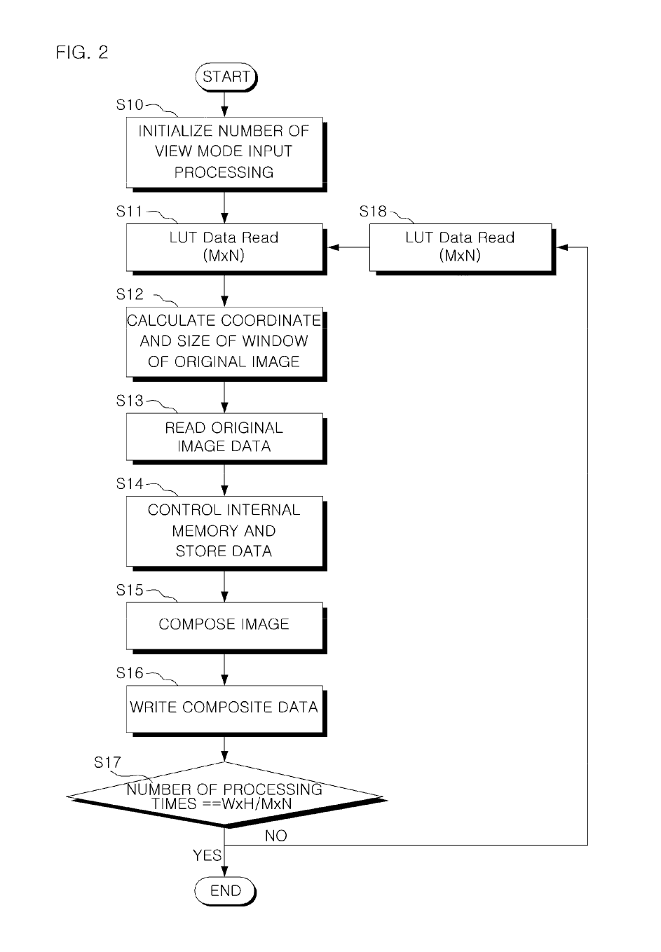

FIG. 2 is a flowchart illustrating an image composing method according to an exemplary embodiment of the present invention.

Referring to FIG. 2, first, an around view monitoring (AVM) system is initialized in step S10. For example, the number of view mode input processing times is initialized. Next, images at front, rear, left, and right sides of the vehicle are captured to be stored in the external memory as four original images.

The image composing apparatus 1 reads an M×N basic pixel group and a look up table from the external memory in step S11. The image composing apparatus 1 calculates a starting coordinate and a window size of a window based on the look up table in step S12.

The image composing apparatus 1 reads out original images corresponding to the starting coordinate and the window size of the window from the external memory in step S13 to store the original images in an internal memory in step S14. The image composing apparatus 1 composes the original images read out from the internal memory in step S15 to store the original images in the external memory as data of composite images in step S16.

In this case, the image composing apparatus 1 checks whether the composite image data has a size of M×N which is a basic pixel group unit in step S17, and if the composite image data is smaller than the basic pixel group unit, increases the number of processing times in step S18 and repeats the image composing processes of steps S11 to S16.

When an entire composite image is completed, the image composing apparatus 1 outputs the composite image to the display device.

The present invention has been described with reference to the exemplary embodiment illustrated in the drawing, but the exemplary embodiment is only illustrative, and it would be appreciated by those skilled in the art that various modifications and equivalent exemplary embodiments may be made therefrom. Accordingly, the actual scope of the present invention must be determined by the technical spirit of the appended claims.

What is claimed is:

1. An image composing apparatus, comprising:
an image input unit which captures original images which are captured by cameras of a vehicle;
an original image window generating unit which sets a pixel group to analyze a coordinate value and calculates the window in accordance with the coordinate value;
an internal memory control unit which reads the original images from the external memory in accordance with the window to store the original image in an internal memory; and
an image composing unit which composes the original images read out from the internal memory based on the coordinate value to generate the composite image.

2. The image composing apparatus of claim 1, wherein the original image window generating unit performs pixel processing by grouping M×N basic pixels.

3. The image composing apparatus of claim 1, wherein the original image window generating unit calculates a starting coordinate and a window size of the window.

4. The image composing apparatus of claim 3, wherein the original image window generating unit calculates the window size based on the basic pixel group.

5. The image composing apparatus of claim 1, wherein the internal memory control unit transmits the coordinate values as many as the number of M×N basic pixels to the image composing unit.

6. The image composing apparatus of claim 1, wherein the original image window generating unit performs a backward mapping in the unit of window to correct the distortion.

7. The image composing apparatus of claim 1, wherein the image composing unit repeats the image composing process if the composite image data is smaller than the basic pixel group unit.

8. The image composing apparatus of claim 1, further comprising:
an image output unit which reads the composite image from the external memory to output the composite image to a display device.

9. An image composing method, comprising:
initializing an around view monitoring (AVM) system;
capturing images around a vehicle to store the images in an external memory as original images;
calculating a window based on a pixel group and a look up table which are read out from the external memory;
storing the original images corresponding to the window in an internal memory; and
composing the original images which are read out from the internal memory to store the original images in the external memory as a composite image.

10. The image composing method of claim 9, wherein M×N basic pixels are grouped together to be subjected to pixel processing.

11. The image composing method of claim 9, wherein the calculating calculates a starting coordinate and a window size of the window.

12. The image composing method of claim 9, wherein the calculating analyzes the coordinate value based on the look up table which is read out from the external memory as a window having the basic pixel group unit and calculates the starting coordinate and the window size in accordance with the coordinate value.

13. The image composing method of claim 12, wherein the storing as a composite image stores the coordinate values as many as the number of M×N basic pixels as a coordinate value of the composite image.

14. The image composing method of claim 9, wherein the internal memory is a static random access memory (SRAM).

15. The image composing method of claim 9, wherein the external memory is a nonvolatile memory or a dynamic random access memory (DRAM) and is accessed by a burst read operation mode.

16. The image composing method of claim 9, further comprising:
performing a backward mapping in the unit of window to correct the distortion.

17. The image composing method of claim 9, wherein the composing repeats the image composing process if the composite image data is smaller than the basic pixel group unit.

18. The image composing method of claim 9, further comprising:
outputting the composite image read from the external memory to a display device.
